(19) United States
(12) Patent Application Publication
(10) Pub. No.: US 2016/0327074 A1
(43) Pub. Date: Nov. 10, 2016

(54) SYSTEMS AND METHODS FOR DISPENSING POLYMER FASTENERS

(71) Applicant: 3M INNOVATIVE PROPERTIES COMPANY, Saint Paul, MN (US)

(72) Inventors: Joseph D. Rule, Woodbury, MN (US); Sharon Wang, St. Paul, MN (US)

(21) Appl. No.: 15/104,903

(22) PCT Filed: Dec. 16, 2014
(86) PCT No.: PCT/US2014/070439

§ 371 Date: Jun. 15, 2016

Related U.S. Application Data
(60) Provisional application No. 61/916,421, filed on Dec. 16, 2013.

(51) Int. Cl. F16B 1/00; B26D 5/16; B26D 7/06; B26D 1/06

(52) U.S. Cl. CPC F16B 1/0014; B26D 1/065; B26D 5/16; B26D 7/0683

(57) ABSTRACT

A dispensing device (100) is configured to dispense polymer fasteners from a strand of oriented shape memory polymer configured to expand laterally and contract longitudinally when heated. The dispensing device includes a strand dispenser (101) arranged to dispense the strand. A strand metering mechanism (102) is operable in conjunction with the strand dispenser to dispense a predetermined length of the strand. A cutting mechanism (103) is configured to cut the strand to form a polymer fastener of predetermined length.

### TECHNICAL FIELD

This application relates generally to tools for dispensing polymer fasteners as well as methods pertaining to the dispensing of polymer fasteners.

### BACKGROUND

There are many applications in which two workpieces are permanently or semi-permanently connected together. Fasteners such as screws, bolts, rivets, etc., may be used in such applications. In some implementations, it is useful to join workpieces with blind joints with fasteners that are not visible and/or are not accessible to observers. Blind joints can provide an aesthetically pleasing appearance and can be more tamper proof than non-blind joints because the fasteners are hidden and the joint itself is less obvious.

### SUMMARY

Some embodiments are directed to a fastener dispensing device. The device includes a strand dispenser configured to dispense a strand, the strand comprising an oriented shape memory polymer configured to expand laterally and contract longitudinally when heated. The strand dispenser includes at least two grippers that operate cooperatively to dispense the strand. A strand metering mechanism is configured to be operable in conjunction with the strand dispenser to dispense a predetermined length of the strand. A cutting mechanism is configured to cut the strand to form a fastener of the predetermined length.

Some embodiments involve a method of operating a fastener dispensing device. The fastener dispensing device includes a strand dispenser, a metering mechanism, and a cutting mechanism that are operably connected. The method includes operating a strand dispenser to dispense a strand and operating a metering mechanism to meter the amount of strand dispensed to a predetermined length. The strand comprises an oriented shape memory polymer configured to expand laterally and contract longitudinally when heated. After the dispensing and metering, the strand is cut to form a fastener of the predetermined length.

Some embodiments involve a device that includes a strand dispenser configured to dispense a strand of an oriented shape memory polymer that is configured to expand laterally and contract longitudinally when heated. A strand metering mechanism is configured to be operable in conjunction with the strand dispenser to dispense a predetermined length of the strand. A cutting mechanism is configured to cut the strand to form fasteners of the predetermined length.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 is a conceptual block diagram of a device configured to dispense a specified amount of polymer strand and to cut the polymer strand to a predetermined length forming a polymer fastener in accordance with some embodiments;

FIG. 2 is a flow diagram illustrating a method of operating the device of FIG. 1;

FIGS. 3A-3C illustrate an example of a manually operated strand dispensing device 300 that is capable of being manually operated to dispense and cut polymer fasteners of a predetermined length;

FIG. 4 is an exploded view of a collet and tapered sleeve gripper that can be used in a strand dispensing device;

FIGS. 5A-5C provide more detailed views of the second handle of the device illustrated in FIGS. 3A and 3B;

FIGS. 6A-6B provide more detailed views of the first handle of the device illustrated in FIGS. 3A and 3B;

FIG. 7 provides a more detailed view of the cam plate of the device illustrated in FIGS. 3A and 3B;

FIGS. 8A-8D provide more detailed views of the base plate of the device illustrated in FIGS. 3A and 3B;

FIGS. 9A-9B provide more detailed views of the cam follower collar of the device illustrated in FIGS. 3A and 3B;

FIG. 10 is a conceptual block diagram of an automated system including a device configured to dispense a specified amount of polymer strand and to cut the polymer strand to a predetermined length forming a polymer fastener in accordance with some embodiments; and

FIG. 11 illustrates the device of FIG. 10 in relation to a workpiece.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments described herein involve systems for dispensing polymer fasteners that can be transformed into rivets used to join workpieces. These rivets can be used, for example, to provide blind or double blind joints where the rivet is not visible or accessible from one or both sides of the joint. The fasteners are formed of a length of an oriented shape memory polymer strand configured to expand laterally and contract longitudinally when heated. The strand may be cut into individual fasteners of a predetermined length that may be adjustable depending on the application. When the fasteners are heated, they shorten in length and expand in diameter. The transformation of the fastener material forms rivet heads when used in the appropriate substrate geometries.

Shape memory polymers have the ability to be set in a pre-set shape, deformed to an altered shape, and then revert back to the pre-set shape when exposed to the appropriate stimuli (e. g., changes in temperature, application of solvent, etc.). The fasteners discussed herein comprise a shape memory polymer in at least a portion of the fastener. In some implementations, the entire fastener is made from a shape memory polymer. Additional information about shape memory polymer materials that are useful as polymer rivets and methods for using such polymer rivets are further described in U.S. Publication 2012/0017422.

Shape memory polymers have a defined melting point (Tₘ) or glass transition temperature (T_{g}). Collectively, the melting point (Tₘ) or glass transition temperature (T_{g}) can be referred to as the transition temperature (Tₜᵣₐₙₛ). Above the transition temperature, the polymers are elastomeric in nature, and are capable of being deformed with high strain. The elastomeric behavior of the shape memory polymers results from either chemical crosslinks or physical crosslinks (often resulting from microphase separation). The shape memory polymers can be glassy or crystalline and can be either thermosets or thermoplastics.

Generally, the shape memory polymer is chosen such that the Tₜᵣₐₙₛ is at a temperature suitable for fastening workpieces, and above any temperatures to which the fastened workpieces might be expected to be exposed. In some embodiments the Tₜᵣₐₙₛ is at least 50° C., at least 100° C., or at least 125° C. Generally the shape memory polymer will have an elastic modulus of at least 0.5 MPa at 80° C.

Useful shape memory polymers may be physically or chemically crosslinked. Examples of suitable chemical crosslinked shape-memory polymers include, but are not limited to, high density polyethylene, low density polyethylene, and polyethylene/polyvinyl acetate copolymers. Examples of suitable physically crosslinked shape memory polymers include, but are not limited to, linear block copolymers, such as thermoplastic elastomer having a hard segment as permanent shape and having a soft segment as switching temporary shape.

Examples of polymers that have been utilized in hard and soft phases of shape memory polymers include polyurethanes, polynorbornenes, polyethers, polyacrylates, polyamides, polysiloxanes, polyether amides, polyether esters, trans-polyisoprenes, polymethylmethacylates, cross-linked trans-polyoctylenes, cross-linked polyethylenes, cross-linked polyisoprenes, cross-linked polycyclooctenes, inorganic-organic hybrid polymers, copolymer blends with polyethylene and styrene-butadiene co-polymers, urethane-butadiene co-polymers, polymethylmethacrylate, polycaprolactone or oligo caprolactone copolymers, polylactic acids, polylactic acid/polyglycolic acid co-polymers, and photocrosslinkable polymers including azo-dyes, zwitterionic, and other photochromatic materials such as those described in the book Shape Memory Materials (Cambridge University Press 1998) by Otsuka and Wayman.

Suitable shape memory polymers include, but are not limited, to those described in Patent Application Publication WO 03/084489 Lendlein et al.); U.S. Pat. No. 5,506,300 (Ward et al.); U.S. Pat. No. 5,145,935 (Hayashi); U.S. Pat. No. 5,665,822 (Bitler et al.); Gorden, “Applications of Shape Memory Polyurethanes”, in Proceedings of the First International Conference on Shape Memory and Superelastic Technologies, SMST International Committee, pp. 115-19 (1994); U.S. Pat. No. 6,160,084 (Langer); U.S. Pat. No. 6,388,043 (Langer); Kim et al., in Polymer 37(26):578I-93 (1996); Li et al., in J Applied Polymer 62:631-38 (1996); Takahashi et al., in J. Applied Polymer Science 60:1061-69 (1996); Tobushi H., et al., in J Physique IV (Colloque C1) 6:377-84 (1996)); U.S. Pat. No. 5,155,199 (Hayashi); U.S. Pat. No. 7,173,096 (Mather et al.); U.S. Pat. No. 4,436,858 (Klosiewicz); U.S. Patent Application Publication 2005/244353 (Lendlein et al.); U.S. Patent Application Publication 2007/009465 (Lendlein et al.); U.S. Patent Application Publication 2006/041089 (Mather et al.); C. M. Yakachi et al., in Advanced Functional Materials, 18 (2008), 2428-2435; and D. L. Safranski et al., in Polymer, 49 (2008), 4446-4455.

Commercially available thermoplastic shape memory polymers include, but are not limited to, polymethylmethacrylate, poly(t-butyl acrylate) such as those available from PolymerExpert (France) under the trade designation “JTbu”, aliphatic polyether polyutherurethanes such as those available under the trade designation TECOFLEX (TFX) from Noveon Thermedics Polymer Products (Wilmington, Del.), polyether polyurethanes available under the trade designation DIARY (e.g., MM type, MP type, MS type and MB (microbead powder) type) from Diaplex Co., Ltd. (Japan), materials available under the trade designation CALO-MER from the Polymer Technical Group (Berkeley, Calif.), elastic memory composite available under the trade designation EMC from Composite Technology Development, Inc. (Lafayette, Colo.), and materials available under the trade designation VERIFLEX from Cornerstone Research Group (Beavercreek, Ohio).

Shape memory polymer can be produced in the form of an elongated strand of material having a substantially circular cross sectional shape, or having another cross sectional shape. In order for the strand to be useable as rivets, the polymer strand is cut into fasteners of appropriate length segments, where the length of the segments depends on its application. These fasteners can then be placed into their desired location to join two or more workpieces together. For example, in one implementation, a first end of the fastener can be inserted into a cavity in a first work piece and a second end of the fastener can be inserted into a cavity in a second workpiece. The fastener is heated producing longitudinal contraction and lateral expansion of the fastener within the cavities and causing the fastener to securely hold the first and second workpieces together.

In some implementations, longer fasteners can be used to create stronger bonds when compared to shorter fasteners because the additional fastener material of the longer fasteners forms deeper rivet heads when heated. However, the initial length of a fastener may be constrained by other factors, such as the depth of the cavity in a workpiece. In many applications, the fastener is cut to a predetermined length that produces a specified joining strength for a given application.

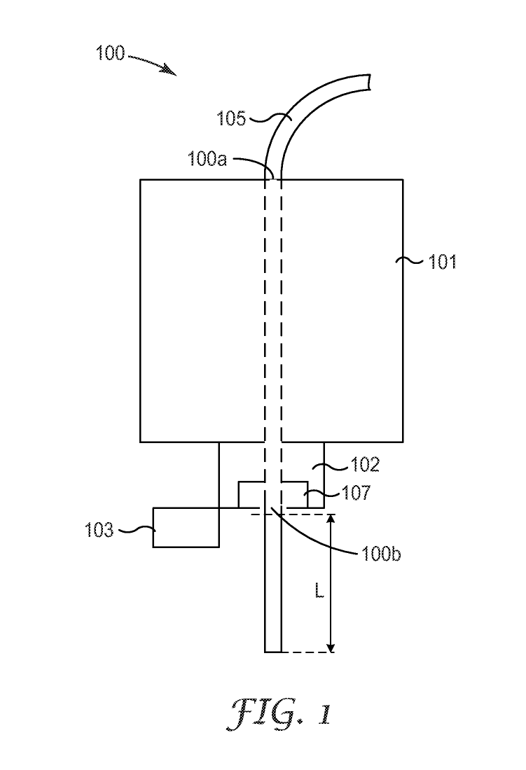

Embodiments described herein involve devices, systems, and methods for dispensing, metering, and cutting a shape memory polymer strand to a predetermined length. Some embodiments involve a device configured to dispense, meter, and cut a controlled, adjustable length of a continuous strand of polymer shape memory material with end deformation within a specified tolerance. FIG. 1 is a conceptual block diagram of a device 100 configured to dispense a metered amount of polymer strand and to cut the polymer strand to a predetermined length, L, to form a polymer fastener. The device 100 comprises a strand dispenser 101, a strand metering mechanism 102, and a cutting mechanism 103. The strand dispenser 101 is configured to dispense the polymer strand 105 from a source (not shown in FIG. 1), such as a strand roll. The strand metering mechanism 102 operates in conjunction with the strand dispenser 101 to control the length of strand dispensed to a specified amount. The cutting mechanism 103 cuts the strand at the predetermined length of the fastener.

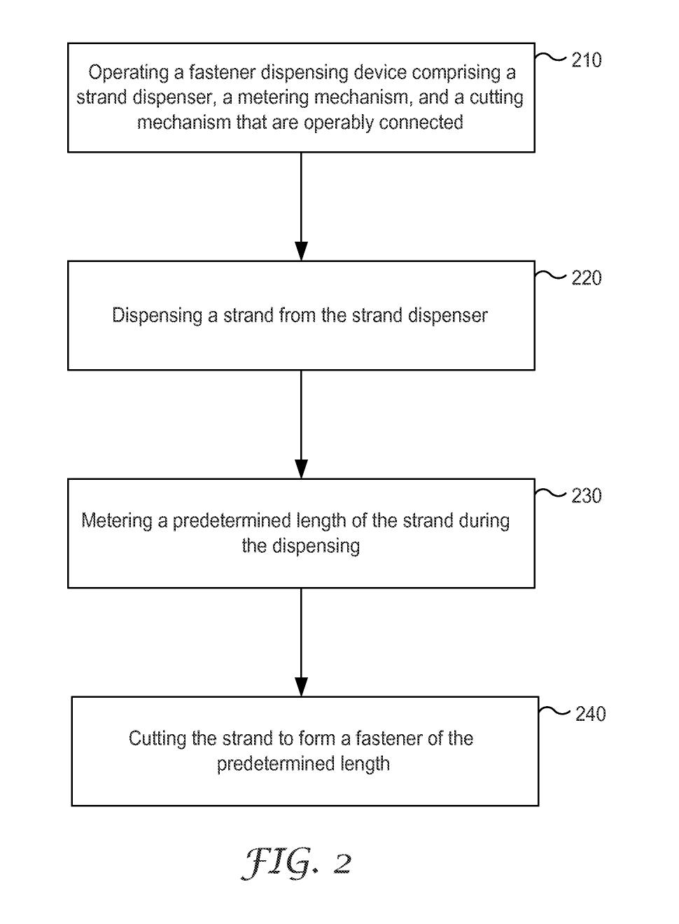

FIG. 2 is a flow diagram illustrating a method of operating 210 a fastener dispensing device. The fastener dispensing device comprises a strand dispenser, a strand metering mechanism, and a cutting mechanism that are operably connected. The method includes operating the strand dispenser to dispense 220 a strand of shape memory polymer material. The shape memory polymer strand is configured to expand laterally and contract longitudinally when heated. The strand dispenser and metering mechanism are operated cooperatively to meter 230 a predetermined length of the strand during the dispensing. The strand is cut 240 to form fasteners of the predetermined length.

In some embodiments, dispensing 220 the fastener may include dispensing a first end of the cut polymer strand fastener into an opening in a first workpiece. The second end of the fastener may be inserted in an opening in a second workpiece. Next, the fastener may be heated to join the first and second workpieces through the transformation of the fastener including both the first and second ends under heat that causes the fastener to laterally expand and longitudinally contract.

In other embodiments, a first end of the polymer fastener is dispensed into an opening in a first workpiece and then heated to transform the fastener in the region of the first end. The heating does not substantially transform the fastener in the region of the second end. After the first end is heated and transformed, a second end of the fastener is placed in a second workpiece and then the second end is heated. The heating of the second end transforms the fastener in the region of the second end. In some embodiments, at least one of the openings in the first or second workpiece is a blind cavity. In some embodiments, at least one of the openings in the first or second workpiece is a through hole. Heating the first end may serve to affix the first end in the first workpiece to facilitate subsequent handling of the first workpiece, such as preventing the fastener from falling out of the through hole or cavity in the first workpiece during insertion of the second end of the fastener in the second workpiece.

In some embodiments, operating 210 the dispensing device comprises manually operating the dispensing device. The dispensing 220, metering 230, and cutting 240 may all occur as the result of user action, such as applying pressure to handles or other operating mechanisms of the dispensing device. In some embodiments, operating 210 the dispensing device comprises operating under automatic control. The dispensing 220, metering 230, and cutting 240 may all function automatically with minimal user input. In yet other embodiments, operating 210 the dispensing device involves operating the device by a combination of some manual and some automatic operations.

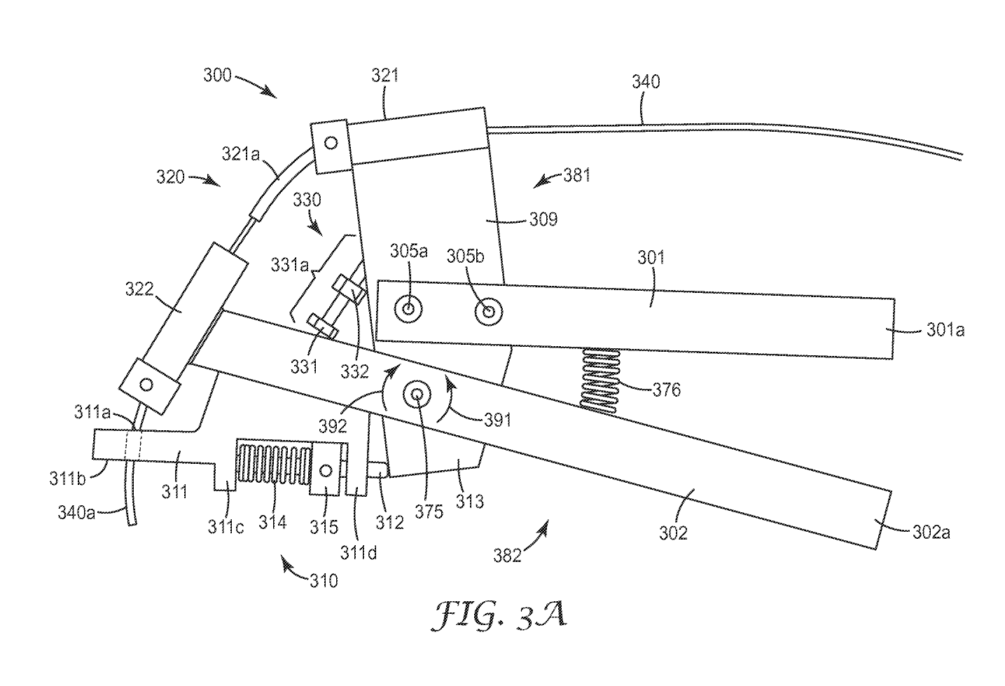

FIGS. 3A and 3B illustrate an example of a dispensing device 300 that is capable of being manually operated to dispense and cut polymer fasteners of a predetermined length. The device 300 comprises a strand dispenser 320, a strand metering mechanism 330, and a strand cutting mechanism 310. The strand dispenser 320 is configured to dispense a polymer strand 340, which is cut to a predetermined length, L, by the cutting mechanism 310 to create fasteners 345 of length L.

In the embodiment illustrated in FIGS. 3A and 3B, the strand dispenser 320 comprises a first structure 381 and a second structure 382. The first structure 381 includes a first handle 301, cam plate 309, and first gripper 321. The first gripper 321 and/or the second gripper 322 can include a hollow tube follower 321a coupled to the gripper 321 that the strand 340 passes through. The tube follower 321a is configured to facilitate guiding the strand 340 to and/or from the gripper 321. The strand metering mechanism 330 shown in FIGS. 3A and 3B includes a stop 331 coupled to the cam plate 309 of the first structure 381. In this particular embodiment, the first handle 301 and the cam plate 309 are separate pieces with the first handle 301 being secured to the cam plate 309 by fasteners, e.g., bolts 305a, 305b. In other embodiments, the handle and cam plate may be formed as a unitary structure.

The second structure 382 includes a second handle 302, base plate 311, and a second gripper 322. The cutting mechanism 310 is attached to the base plate 311. The second structure 382 is rotatably attached to the first structure 381 by a pivot rod 375. A spring 376 is disposed between the first handle 301 and the second handle 302.

In the illustrated example shown in FIGS. 3A and 3B, manual operation of device 300 is accomplished by relative rotational movements between the first structure 381 and the second structure 382. To provide a frame of reference for this discussion, it is assumed that the first structure 381 is fixed and the second structure 382 rotates around the pivot rod 375, however, it will be appreciated that alternatively the second structure 382 could be assumed to be fixed, with the first structure 381 rotating relative to the second structure 382 around pivot rod 375.

FIG. 3A shows the device 300 in the “handles-open” position wherein the second handle 302 has been rotated in the clockwise direction up to the limit imposed by the stop 331. FIG. 3B shows the device 300 in the “handles-closed” position wherein the spring 376 is compressed and the ends 301a, 302a of the handles 301, 302 are touching or close together.

In the “handles-open” position the second structure 382 is able to rotate in the counterclockwise direction (arrow 391) relative to the first structure 381 but additional rotational movement in the clockwise direction (arrow 392) is limited by the stop 331. In the “handles-closed” position the second structure 382 may be able to rotate in the clockwise direction (arrow 392) relative to the first structure 381 and may have limited or no additional rotational movement possible in the counterclockwise direction (arrow 391).

Moving from the “handles-closed” position to the “handles-open” position (also referred to herein as the first relative movement), the clockwise rotation of the second structure 382 relative to the first structure 381 causes the specified amount of strand 340a to be dispensed through an aperture 311a in the base plate. Moving from a “handles-open” position to the “handles-closed” position (also referred to herein as the second relative movement), the counterclockwise rotation (arrow 391) of the second structure 382 relative to the first structure 381 causes the strand that has been dispensed during the first relative movement to be cut, forming fasteners 345 of the predetermined length, L.

It will be appreciated that manual operation of a device configured to dispense polymer strand could be achieved in a number of other ways. The particular example disclosed herein is but one of a multitude of possible configurations for manual operation. Manual operation could be achieved by any manual mechanism that causes a length of polymer strand to be dispensed from a strand source, e.g., a roll, and cut to the predetermined length of the fastener.

To accomplish advancement of the strand with the device illustrated in FIGS. 3A and 3B, the two grippers 321, 322 are forced into motion relative to each other. During the first relative movement, using the arbitrary framework of a stationary first structure 381 and a moving second structure 382, the second structure 382 rotates in a clockwise direction (arrow 392). The spring 376 forces the ends 301a, 302a of the handles 301, 302 apart and causes the second gripper 322 to move closer to the first gripper 321. The first gripper 321 grips the strand 340 and the second gripper 322 allows the strand 340 to move through it. The first movement causes a predetermined amount of strand 340a to be dispensed through an aperture 311a in the base plate 311 of the second structure 382. The amount of rotation of the second structure 382, and thus the length of strand dispensed, is controlled by the stop mechanism 330.

The metering mechanism 330 illustrated in FIGS. 3A and 3B includes a threaded piece 331, such as a bolt, which serves as the stop, and a locking nut 332. In some embodiments, the metering mechanism can be adjustable. For example, as shown in FIGS. 3A and 3B, the exposed portion 331a of the threaded piece 331 between the first and second structures 381, 382 can be adjusted by threading the piece 331 into the plate 309 making the exposed portion 331a smaller, or threading the piece 331 out of the plate 309, making the exposed portion 331a larger.

The metering mechanism 330 operates in conjunction with the strand dispenser 320 to dispense a predetermined amount of strand 340a. A larger exposed portion reduces the clockwise rotation (arrow 392) of the second structure 382 relative to the first structure 381 and reduces the length of the dispensed strand. A smaller exposed portion increases the clockwise rotation (arrow 392) of the second structure 382 relative to the first structure 381 and increases the length of the dispensed strand. The metering mechanism 330 shown in FIGS. 3A and 3B includes a locking nut 332 threaded onto the threaded piece 331. The locking nut 332 can be tightened against the plate 309 to lock the threaded piece 331, providing an exposed portion 331a of predetermined length.

In the device 300 illustrated in FIG. 3C, the cutting mechanism 310 includes a knife blade 316 having a sharp cutting edge (not visible in FIGS. 3A and 3B). The knife blade extends along the dispensing surface 311b of the base plate 311 and is attached at one end to a cam follower 312. The cam follower 312 extends through holes in the first and second protrusions 311c, 311d of the base plate 311. FIG. 3C illustrates the device 300 in a “handles-open” position, after the handles 301, 302 have moved apart during the first movement. In the “handles-open” position the knife blade 316 is positioned away from the predetermined amount of strand 340a.

When the handles 301, 302 move apart during the first movement, the spring 314 around the follower 312 pushes the follower 312 and the knife back away from the cut strand. As the knife moves away, the new piece of strand 340a is extended through the aperture 311a in the base plate 311 as described above.

During the second movement, when the handles 301, 302 are being squeezed together, the cam region 313 of the cam plate 309 pushes against the follower 312 to force the edge of the knife blade through the strand 340. As the handles 301, 302 are squeezed, the knife slides along the dispensing surface 311b and advances toward the strand 340 to cut the strand 340. The strand 340 is held stationary by the second gripper 322 and passes through the aperture 311a. During the second movement, a spring 314 disposed around the cam follower 312 is compressed between a first protrusion 311c of the base plate 311 and a collar 315 secured to the cam follower 312. In some embodiments, the cutting mechanism 310 is configured to cut the polymer strand 340 with less than 25%, less than 10% or even less than 2% distortion of a cross sectional shape of the polymer strand 340.

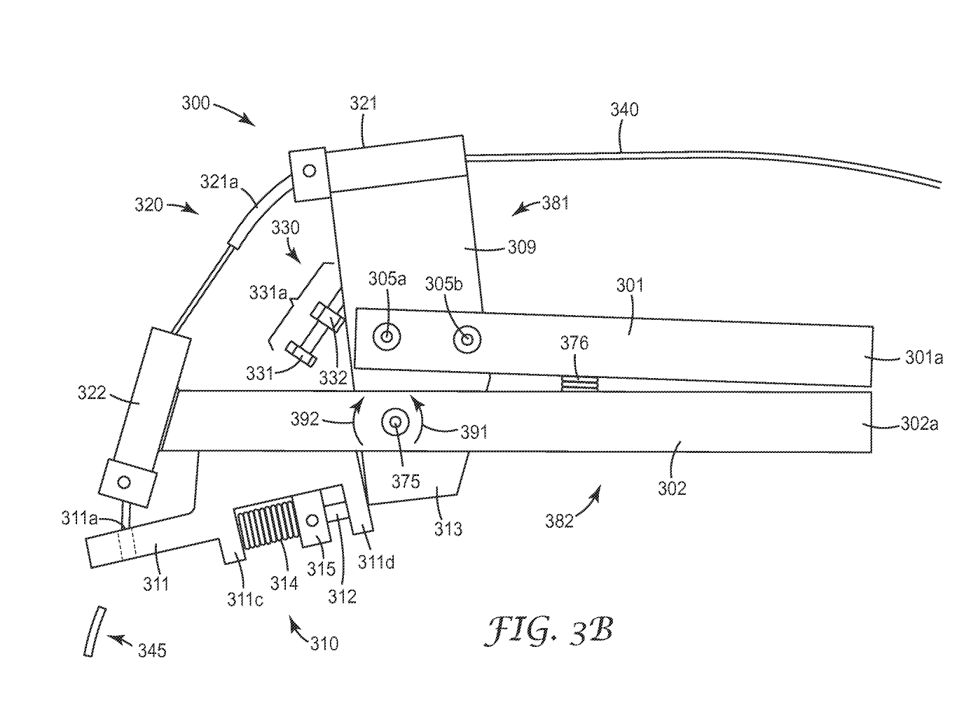

FIG. 4 illustrates a gripper 400 shown in an exploded view. Gripper 400 may be used as the first gripper 321 illustrated in FIGS. 3A and 3B. The second gripper 322 may have the same construction, or may have a different construction from that of the first gripper 321. In the example shown in FIGS. 3A and 3B, the second gripper 322 is similar in some respects to the first gripper 321, but differs in that the second gripper 322 does not include the hollow tube follower 321a.

Gripper 400 shown in FIG. 4 includes collet 402 and a sleeve 401. The sleeve 401 is tapered and the collet 402 can be split into multiple wedges 403. The collet wedges 403 can be internally serrated 404 to better grip the polymer strand. The gripper 400 includes a spring 405 that pushes the collet 402 into the taper of the sleeve 401. The gripper 400 is configured so that when the polymer strand moves in the sleeve 401 towards a wider portion of the taper, in the direction of the arrow in FIG. 4, the collet 402 moves in the sleeve 401 toward the wider portion of the taper and the collet wedges 403 separate allowing the polymer strand to move in the collet 402. The gripper 400 is also configured so that when the polymer strand moves in the sleeve 401 towards the narrower portion of the of the taper, in the opposite direction of the arrow in FIG. 4, the collet wedges 403 close together to grip the polymer strand. The gripper 400 is configured to allow the polymer strand to move in a first direction of the arrow and to inhibit movement of the polymer strand in a second direction, opposite that of the first direction. The gripper 400 may be capable of accommodating multiple polymer strand diameters. The gripper 400 may include a hollow curved tube follower 406 that guides the polymer strand into or out of the gripper 400. The gripper 400 may also include a spring holder 407 that holds the spring 405 inside the sleeve 401.

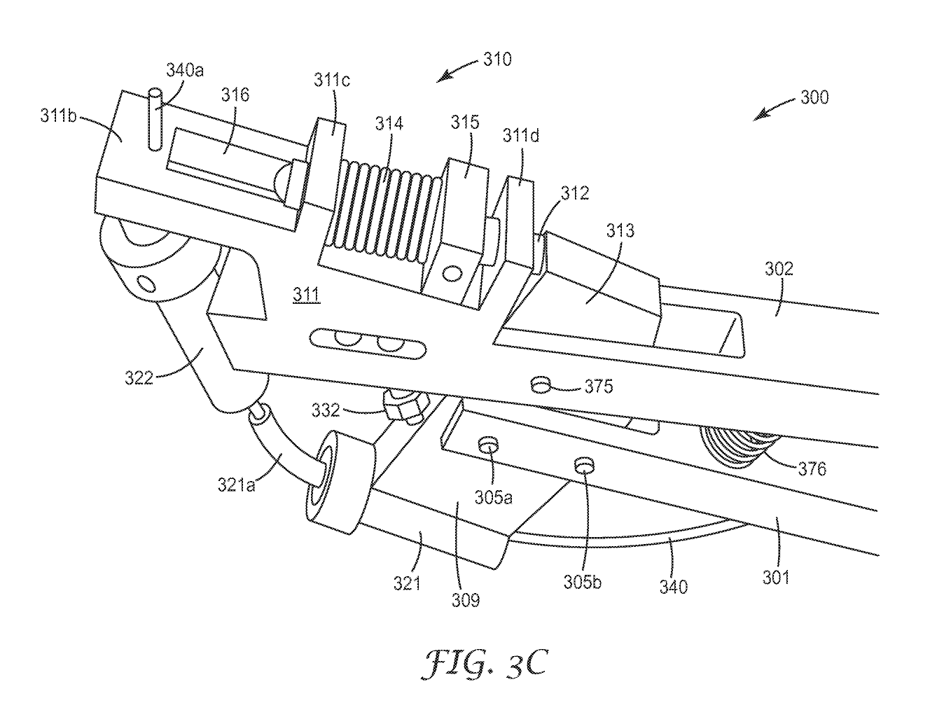

FIGS. 5A-5C illustrate top, side, and bottom views, respectively, of the second handle 302 of the second structure 382. The second handle 302 has a slot 505 through which the cam plate 309 of the first structure 381 (not shown in FIGS. 5A-5C, but shown in FIGS. 3A and 3B) is inserted. The second handle 302 is rotatably attachable to the cam plate 309 with a pivot rod 375 (not shown in FIGS. 5A-5C, but shown in FIGS. 3A and 3B) inserted through holes 501. The second handle 302 is configured to rotate around the pivot rod 375. The second handle 302 includes a spring recess 510 dimensioned and configured to contain the spring 376 disposed between the first handle 301 and the second handle 302. The second handle 302 also includes a recess 520 that facilitates attachment of the base plate 311 (Not shown in FIGS. 5A-5C, but shown in FIGS. 3A and 3B) to the second handle 302.

FIGS. 5A through 5C provide an exemplary shape and dimensions for the second handle 302, although it will be appreciated that the shape and dimensions are illustrative and many other shapes and/or dimensions are possible. All dimensions are approximate and within tolerance values. For example, handle 302 may be made of a 0.75 inch (1.905 cm) square aluminum bar. The length of the handle 302 may be between 8.8 inches (22.352 cm) to 9.0 inches (22.86 cm), the dimensions of slot 505 may be 0.38 inches (0.965 cm) by 2.75 inches (6.985 cm), and the diameters of the holes 501 may be 0.25 inches (0.635 cm). The spring recess 510 may be 0.5 inches (1.27 cm) in diameter and 0.25 inches (0.635 cm) deep and may be positioned 4.25 inches (10.795 cm) from the end 302a of the handle 302. The recess 520 for the base plate may be located adjacent to the slot 501 and may be 0.25 inches (0.635 cm) in width, 1.25 inches (3.175 cm) length, and 0.375 inches (0.95 cm) in depth.

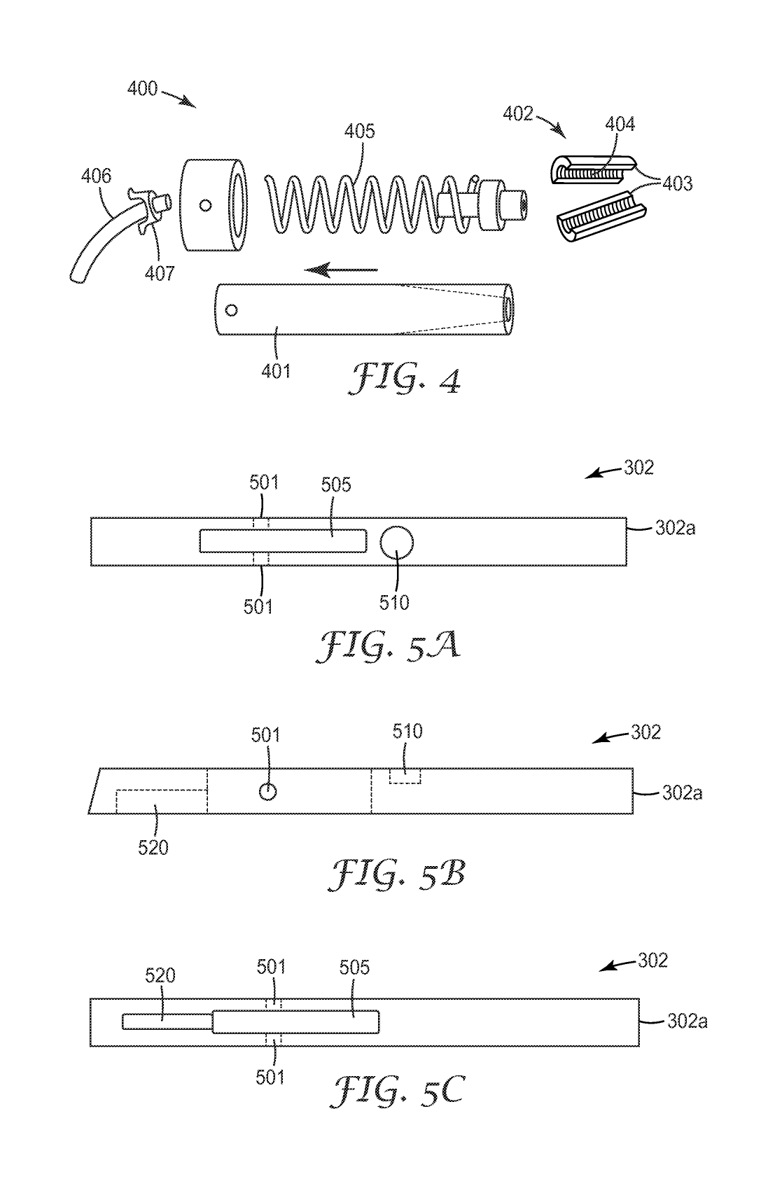

FIGS. 6A and 6B illustrate side and bottom views, respectively, of the first handle 301. The first handle 301 includes two holes 601 through the handle 301 that are dimensioned to accept bolts 305a, 305b (not shown in FIG. 6A but shown in FIGS. 3A and 3B). Bolts 305a, 305b secure the first handle 301 to the cam plate 309 (not shown in FIG. 6A but shown in FIGS. 3A and 3B). The cam plate 309 fits into the cam mount recess 602 of the first handle 301 and is secured to the first handle 301 by fasteners through holes 601. The first handle 301 includes a spring recess 610 configured to contain a spring 376 (not shown in FIG. 6A but shown in FIGS. 3A and 3B) disposed between the second handle 302 and the first handle 301.

FIGS. 6A and 6B provide an exemplary shape and dimensions for a first handle 301, although it will be appreciated that the shape and dimensions are illustrative and many other shapes and/or dimensions are possible. All dimensions are approximate and within tolerance values. For example, handle 301 may be made of a 0.75 inch (1.905 cm) square aluminum bar. The length of the handle 301 may be 6.5 inches (16.51 cm). Holes 601 may be 0.25 inches (0.635 cm) in diameter and may be located 0.375 inches (0.953 cm) and 1.375 inches (3.493 cm), respectively, from the end 301b of the handle 301. The cam plate slot 602 may have dimensions of 0.375 inches (0.953 cm) by 2 inches (5.08 cm). The spring recess 610 may be located 3.73 inches (9.474 cm) from the end 301a, and may be 0.625 inches (1.588 cm) in diameter and 0.25 inches (0.635 cm) deep.

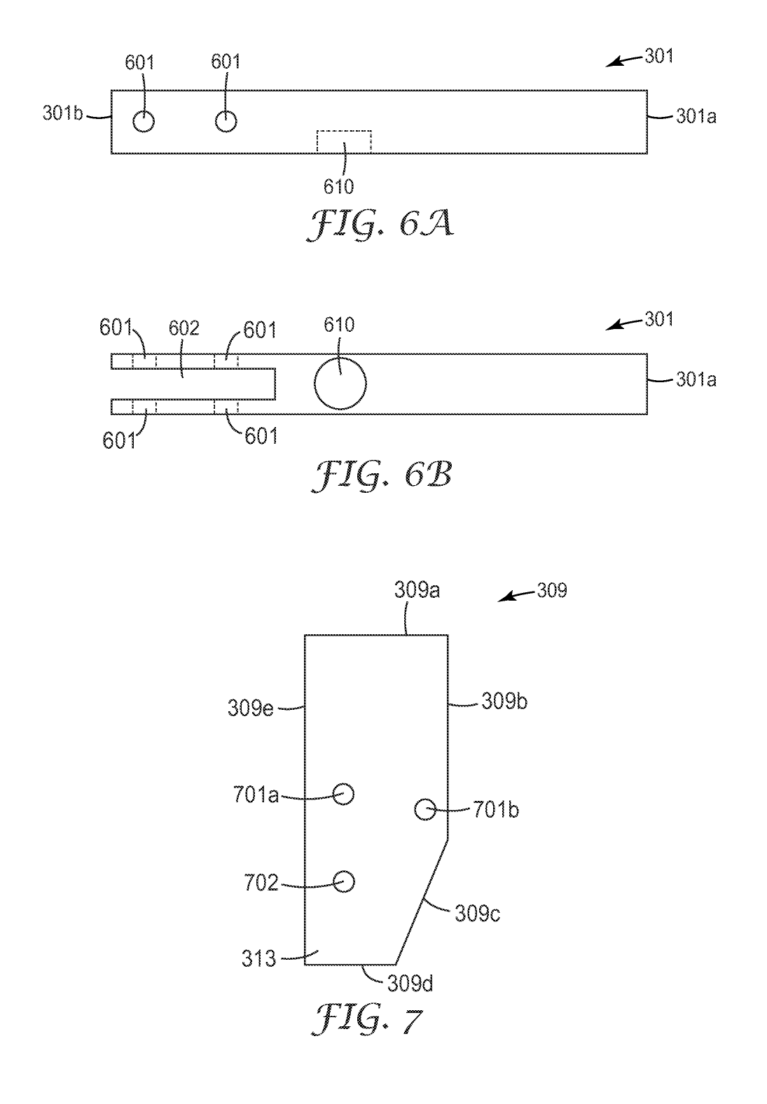

FIG. 7 illustrates the cam plate 309 of the first structure 381. The cam plate 309 is configured to be rotatably coupled to the second handle 302 (not shown in FIG. 7, but shown in FIGS. 3A and 3B). The cam plate 309 includes a cam region 313 configured to push the cam follower 312 of the cutting mechanism (not shown in FIG. 7, but shown in FIGS. 3A and 3B) during the second movement. The cam plate 309 is configured to be connected to the first handle 301 (not shown in FIG. 7, but shown in FIGS. 3A and 3B) by fasteners, e.g., bolts, disposed through holes 701a, 701b. The cam plate 309 is configured to be rotatably connected to the second handle 302 through hole 702, e.g. by a pivot rod 375 shown in FIGS. 3A and 3B. The second handle can pivot around the pivot rod 375 inserted into hole 702 and, as a result, move relative to the first structure comprising the first handle and cam plate.

FIG. 7 illustrates an exemplary shape and dimensions for the cam plate 309, although it will be appreciated that the shape and/or dimensions are illustrative and many other shapes and/or dimensions are possible. All dimensions are approximate and within tolerance values. For example, the cam plate 309 may be a 0.375 inch (0.953 cm) thick pentagonal plate having edges 309a, 309b, 309c, 309d, and 309e. Edges 309a, 309b, 309d, and 309e, may have dimensions 1.75 inches (4.445 cm), 2.5 inches (6.35 cm), 1.125 inches (2.858 cm), and 4.0 inches (10.16 cm), respectively. Hole 701a may be located 1.94 inches (4.928 cm) from edge 309a and 0.5 inches (1.27 cm) from edge 309e. Hole 701b may be located 2.10 inches (5.334 cm) from edge 309a and 1 inch (2.54 cm) from hole 701a. Hole 702 may be located 1 inch (2.54 cm) from edge 309d and 0.5 inches (1.27 cm) from edge 309e.

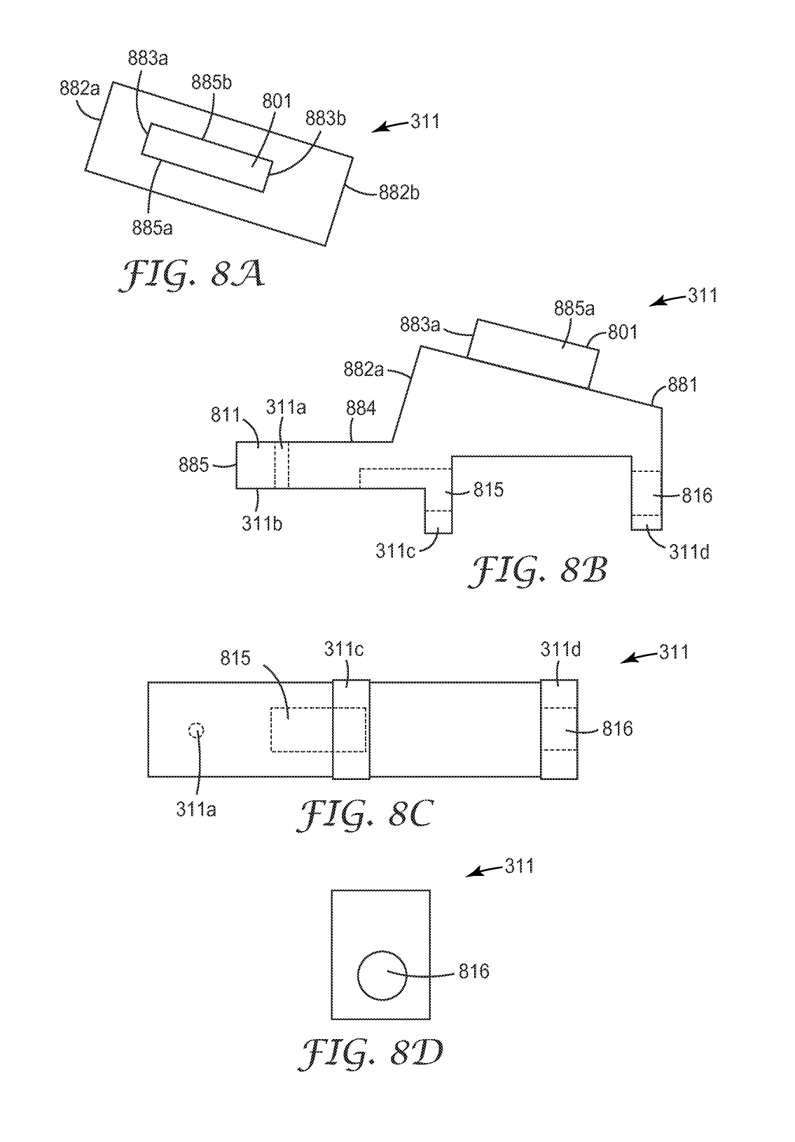

FIGS. 8A-8D illustrate a base plate 311. FIG. 8A is an angled top view of the base plate 311. FIG. 8B is a side view, FIG. 8C is a bottom view, and FIG. 8D is a rear view, respectively, of the base plate 311. The base plate 311 has a protrusion 801 configured to be inserted into a recess 520 (shown in FIGS. 5A-5C) in the second handle 302 to connect the base plate 311 and the second handle 302. The base plate 311 includes base plate protrusions 311c, 311d. Apertures 815, 816 through base plate protrusions 311c, 311d, respectively, are configured to allow the cam follower to be inserted into apertures 815, 816. The base plate 311 includes a dispensing portion 811 having a dispensing surface 311b and dispensing aperture 311a dimensioned to allow the polymer strand to pass through the dispensing aperture 311a.

FIGS. 8A-8D illustrate an exemplary shape and dimensions for the base plate 311 although it will be appreciated that the shape and dimensions are illustrative and many other shapes and/or dimensions are possible. All dimensions are approximate and within tolerance values. For example, the protrusion 801 of the base plate 311 may be 1 inch (2.54 cm) along sides 885a, 885b and may be 0.25 inches (0.635 cm) along sides 883a, 883b. The protrusion 801 may have a height of 0.32 inches (0.813 cm) above the surface 881. The protrusion 801 can be located 0.375 inches (0.953 cm) from side 882a and 0.625 inches (1.588 cm) from side 882b.

Surface 881 may be angled such that surface 881 rises 0.75 inches (1.905 cm) above the top surface 884 of the base plate extension 811. Apertures 815 and 816 can have a diameter of 0.625 inches (1.588 cm). Aperture 816 extends through the base plate protrusion 311d, which has a thickness of 0.25 inches (0.635 cm). Aperture 815 extends through base plate protrusion 311c, which has a thickness of 0.25 inches (0.635 cm), and extends into the base plate extension 811 by an additional 0.5 inches (1.27 cm). Aperture 311a is located 0.375 inches (0.953 cm) from base plate side 885.

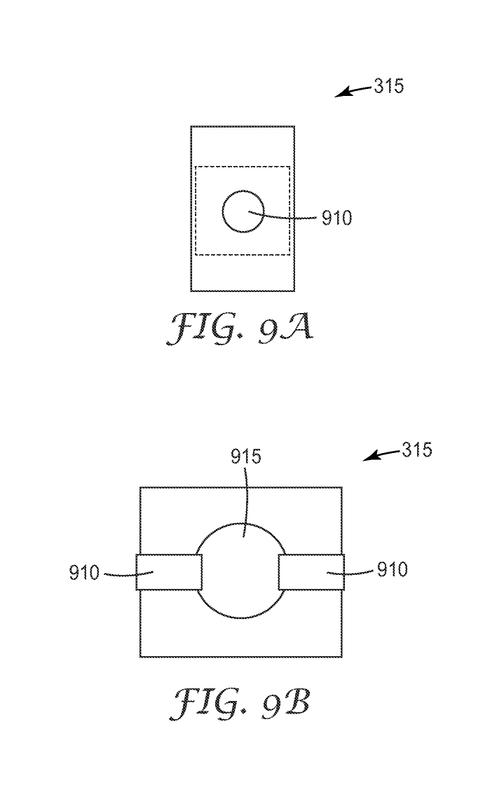

FIGS. 9A and 9B illustrate side and front views, respectively, of a collar 315 for a cam follower. As previously discussed, the collar 315 is configured to compress a spring coupled to the knife blade during the cutting motion. The collar includes an aperture 915 configured to fit around the cam follower 312 (not shown in FIGS. 9A and 9B, but shown in FIGS. 3A and 3B). Set screws 910 are configured to secure the collar 315 to the cam follower 312.

FIGS. 9A and 9B illustrate an exemplary shape and dimensions for the collar 315 although it will be appreciated that the shape and dimensions are illustrative and many other shapes and/or dimensions are possible. For example, the collar 315 may have a height of 0.625 inches (1.588 cm), a width of 0.75 inches (1.905 cm), and a thickness of 0.375 inches (0.953 cm). The diameter of the aperture in the collar may be 0.325 inches (0.826 cm).

Returning now to the conceptual diagram of FIG. 1, it will be appreciated that the functions of the strand dispenser 101, strand metering mechanism 102, and strand cutting mechanism 103 may be accomplished in many different ways. Thus, the device 100 shown in FIG. 1 may utilize components 101, 102, 103 having many forms and dimensions.

The strand dispenser 101 pulls the polymer strand 105 from a source (not shown in FIG. 1) and moves the polymer strand 105 from an input 100a to an output 100b of the device 100. In various configurations, the strand dispenser 101 may comprise one or more grippers, one or more dispensing rollers, one or more rotary motors, one or more linear actuators, one or more collet and sleeve grippers, one or more ratchet wheels, one or more spring loaded clamps, or any other mechanism that is capable of assisting the movement of the polymer strand 105 from the input 100a to the output 100b of the device 100. The strand dispenser 101 may include components of different types configured to operate together to move the polymer strand. For example, in some embodiments, the strand dispenser may include a combination of grippers, ratchet wheels, spring-loaded clamps, dispensing wheels, stepper motors, linear actuators, etc.

As discussed at least in connection with FIGS. 3A and 3B, in some embodiments, multiple grippers may be used in moving the polymer strand 105 from the input 100a to the output 100b of the device 100. The grippers hold onto the polymer strand 105 while moving the polymer strand 105 toward an output of the device 100. In some embodiments, each gripper allows the polymer strand 105 to move through the gripper in one direction but not in another direction. The grippers may function together to progress the polymer strand between the multiple grippers and toward the device output.

In some embodiments, the strand dispenser 101 comprises one or more collet and tapered sleeve grippers. The collet and tapered sleeve grippers may be used to allow the polymer strand 105 to move in one direction, but not the opposite direction. Multiple collets can be used to move the polymer strand 105 by cooperatively moving the multiple collets relative to one another.

In another embodiment, the strand dispenser 101 comprises at least one dispensing roller. The dispensing roller assists in gripping and moving the polymer strand 105 through the device 100. In one embodiment, the polymer strand is disposed between a dispensing roller and a static element, such as a plate. The distance between the outermost edge of the roller and the plate is slightly smaller than the diameter of the polymer strand 105 to ensure pressure on the polymer strand 105. In another embodiment, the polymer strand is disposed between two dispensing rollers. The dispensing rollers may be capable of spinning in counterclockwise and/or clockwise directions, and as a result, moving the polymer strand 105 in a multiple directions. Where multiple rollers are used, the multiple rollers may be two rollers positioned directly across from one another, forming a straight line between the two centers of the rollers that is perpendicular to the lengthwise direction of the polymer strand 105. The distance between the outermost edges of the rollers is slightly smaller than the diameter of the polymer strand 105 to ensure pressure on the polymer strand 105. In some embodiments, the two or more dispensing rollers may be offset with one another along a length of the polymer strand.

In some embodiments, the strand dispenser 101 comprises at least one electromechanical motor, such as AC or DC rotary motor. The motor may be coupled to a dispensing roller so that the motor rotates the roller to control the movement of the polymer strand 105 toward the device output 100b. The motor may comprise a stepper motor that moves in discreet increments and is capable of controlling the dispensing of the polymer strand 105.

In some embodiments, the strand dispenser 101 comprises a ratchet wheel including a pawl and cogwheel arrangement. The pawl and cogwheel may be used to move the polymer strand 105 toward the output 100b of the device 100. The ratchet wheel may provide small increments of movement of the polymer strand 105 based on the size of teeth on a cogwheel. The ratchet wheel may be used in combination with an electromechanical motor or some other type of device to rotate the cogwheel.

In another embodiment, the strand dispenser 101 may comprise at least one spring loaded clamp. Two spring loaded claims may be used together as previously discussed to alternately grip the polymer strand and allow the polymer strand to pass through the clamps to move the polymer strand toward the output. A stepper motor, rotary motor, dispensing roller, and/or linear actuator may be used in combination with the spring loaded clamp to assist in moving the polymer strand 105.

In another embodiment, the strand dispenser 101 may comprise a mechanical or electromechanical linear actuator, such as a lead screw or solenoid. For example, the linear actuator may be coupled to the spring loaded clamps to open and close the clamps.

The device 100 also comprises a strand metering mechanism 102. The strand metering mechanism 102 controls the amount of polymer strand 105 that passes from the input 100a to the output 100b of device 100. By controlling the amount of polymer strand 105 that passes to the output 100b, the strand metering mechanism 102 can control the amount of polymer strand that is dispensed and the length, L, of the fastener that is cut from the polymer strand. The strand metering mechanism 102 may be adjusted to dispense a specific amount of polymer strand 105. The strand metering mechanism 102 may further comprise a calibration mechanism to ensure the strand metering mechanism 102 is dispensing the intended amount of polymer strand 105. The calibration mechanism allows the user to account for imperfections in the device or potential drift in accuracy of the strand metering mechanism 102 over the device's course of use. The strand metering mechanism 102 may comprise a stop feature, a metering wheel, and/or a software algorithm operating in conjunction with a stepper motor, an encoder, or any other component that facilitates the metering of a specified amount of the polymer strand 105 to be dispensed.

The metering mechanism is capable of stopping the strand dispenser 101 at a specific moment to dispense a specified amount of polymer strand 105. The metering mechanism may inhibit the strand dispenser 101 from dispensing additional polymer strand 105 until the polymer strand 105 has been cut by the cutting mechanism 103 to a form a fastener of predetermined length. The metering mechanism may include an adjusting component configured to adjust the metering mechanism to set the amount of polymer strand 105 that is dispensed at the output of the strand dispenser 101 and/or the length, L, of the fasteners cut from the strand. The adjustable component may be controlled by a dial, buttons, or any other input device that would allow the metering mechanism to be set to a particular state corresponding to a specified amount of strand dispensed and/or a predetermined fastener length, L. The adjusting component may be capable of locking into position to prevent the strand metering mechanism 102, once locked, from varying the amount of strand dispensed between cuts of the polymer strand 105.

The metering mechanism may have an element that displays an indicator of the amount of polymer strand 105 that will be dispensed and/or the length, L, of the polymer strand 105 that is to be cut by the cutting mechanism 103. The display may be a digital display, an analog display, a rule, or any other feature that provides an indication of the amount of polymer strand that will be dispensed by metering mechanism and/or the length, L of the fasteners to be cut from the strand.

In some embodiments, the strand metering mechanism 102 comprises a metering wheel. The metering wheel controls the amount of polymer strand 105 that moves through the device 100 and to the cutting mechanism 103. The metering wheel may have adjustable features described above. In some embodiments, the strand metering mechanism 102 comprises an encoder operating in conjunction with an electromechanical actuator such as a motor or linear actuator. An encoder can be arranged to provide an electrical signal or other indication related to the amount of strand dispensed and this signal can be used to control the dispensing of the strand.

The polymer strand is metered so that fasteners of predetermined length, L, are produced. There may be depth tolerances associated with cavities in the workpiece that polymer strand fasteners are placed into. Therefore, the metering mechanism may be arranged so that the fasteners are produced with a length that is within tolerance limits. If the fastener is too long, the fastener may not fit its designated cavity. Fasteners that are too short may result in fastener rivet heads having volumes that are below specified values. In some embodiments, the metering mechanism 102 is configured to meter the dispensed polymer strand so that the length of the fasteners is within 10%, 5%, or even 1% of the predetermined length, L.

The device 100 comprises a cutting mechanism 103. The cutting mechanism 103 can include at least one cutting feature arranged at a first location relative to the polymer strand 105. In some implementations, the cutting feature can include a blade having a sharp edge. The cutting feature may be configured to move across a dispensing surface of the device 100 towards the polymer strand 105. In some embodiments, the cutting mechanism 103 may further include a cutting stop to limit the motion of the cutting feature.

The cutting action occurs after a strand dispensing action during which the strand dispenser 101 dispenses a specified length of polymer strand 105. The cutting action cuts the strand into fasteners of a predetermined length, L. After the cutting feature cuts through the polymer strand 105, the cutting mechanism can be configured to return the cutting feature to its previous position in preparation for the next cut. For example, the cutting mechanism 103 may include a cutting feature retraction device, such as a spring, that retracts the cutting feature after the cutting action.

The polymer strand 105 may be held in place by a strand holder and/or gripper that is configured to limit movement of the polymer strand 105 while the strand 105 is being cut by the cutting mechanism 103. In some implementations, the strand holder comprises an aperture in the dispensing surface. The diameter of the aperture is larger than the strand diameter, allowing the strand 105 to move relatively freely along its longitudinal axis through the aperture, but limiting lateral movement of the strand 105 within the aperture. When a gripper is used in conjunction with an aperture, the aperture limits lateral movement and the gripper limits longitudinal movement of the strand during the cutting process. The lateral strand holder, the gripper, or both used together, facilitate an even cut to the polymer strand 105 and consistency between cut lengths.

The cutting mechanism 103 may comprise a knife blade, a scissors, a pincer, a saw blade, a rotary blade, a wire, a blunt edge, a pair of shear plates or any other feature that would assist in cutting the polymer strand 105.

The cutting mechanism 103 may comprise a knife blade having a sharp edge configured to provide a relatively smooth and clean cut of the polymer strand 105. The cutting mechanism may include a sharpening device that maintains the knife blade edge to a specified sharpness. The cutting edge of the knife blade may be straight, curved, or angled. For example, the cutting edge of the knife blade may have a semi-circle indentation in the blade material that is similar to the outer shape of the polymer strand 105. This indented half circle knife blade shape may distribute the forces applied on the polymer strand 105 resulting in a cleaner cut.

The cutting mechanism may have multiple blades that converge on the polymer strand 105. In some embodiments, the cutting mechanism may include two blades disposed on opposite sides of the polymer strand. For example, two indented semicircular circle knife blade may be disposed on opposite sides of the polymer strand 105, proving a large amount of cutting blade contact with the polymer strand 105. The cutting mechanism 103 may comprise a scissor, a pincer mechanism, or multiple shear plates.

When cutting the polymer strand 105, it is possible to distort the cross sectional shape of the polymer strand 105. For circular cross section strands, the distortion can increase the cross sectional diameter of the strand at some points. The tolerances associated with the holes that polymer strand fasteners are placed can be relatively small. Therefore, the cutting mechanism may be arranged so that the polymer strand 105 substantially maintains its original cross sectional shape and does not substantially distort when cut. If the polymer strand 105 is substantially distorted, the resultant polymer rivet fastener may not fit into its designated hole. In some embodiments, the cutting mechanism 103 is configured to cut the polymer strand 105 with less than 25%, less than 10% or even less than 2% distortion of a cross sectional shape of the polymer strand 105. In some embodiments, the knife blade or the multiple shear plates may cut the polymer strand 105 with less deformation and distortion of a cross sectional shape of the polymer strand 105 than other cutting features.

In some embodiments, the device 100 may also include a heater 107. The heater may be located near the spot where the polymer strand 105 and cutting mechanism 103 interact at the output 100b. The heater 107 can be arranged to heat a fastener after it is cut off from the polymer strand 105. The heater 107 may be configured to heat the fastener at both ends. In some embodiments, the heater may be configured to heat the fastener at a first end, but to not substantially heat the fastener at its opposite end. The heater 107 raises the temperature of the polymer material of the fastener above its transition temperature such that it expands laterally and contracts longitudinally to secure the fastener in the location it is placed. The heater 107 may comprise a heat shielding that protects the polymer strand 105 from the heater 107. Using the heat shield, the polymer strand 105 can be protected from stray heat so that the polymer strand that has not yet been dispensed from the device retains its original shape. In some embodiments, the heater is located on the side of the fastener farthest from the point of the polymer strand 105 that is cut. Some embodiments allow for the fastener to be heated on both ends, other embodiments allow for heating only at one end of the fastener.

In some embodiments, the strand dispenser 101 is configured to dispense multiple polymer strands from multiple sources, to dispense multiple strands of multiple diameters, and/or to dispense multiple strands of different types or lengths. Dispensing multiple polymer strands may increase the efficiency of the device 100 by increasing the production and/or placement of fasteners. In some configurations, the device is configured so that the multiple strands can be dispensed using one strand dispenser 101, one strand metering mechanism 102 and/or one cutting mechanism 103. In other embodiments, the device is configured so that each polymer strand of the multiple strands may have its own strand dispenser 101, its own strand metering mechanism 102, and/or its own cutting mechanism 103.

In some embodiments, the strand dispenser 101 is configured to allow selection of the source of the polymer strand from multiple possible strand sources. For example, the strand dispenser may be configured to allow selection of a polymer strand from multiple sources, wherein each source provides a strand of a different diameter. In this configuration, the diameter of the strand dispensed is selectable, either automatically or manually. The device 100 of this embodiment would be capable of being used for dispensing strands of multiple diameters without having to reconfigure the device to change the strand source. The strand dispenser 101 could comprise an input capable of accepting polymer strands from multiple sources, and an output capable of dispensing one strand, sequentially dispensing multiple strands and/or dispensing multiple strands substantially simultaneously.

The strand dispenser 101 may be capable of selecting a polymer strand from a first source, moving the selected strand to the output 100b using the strand dispenser 101, metering a specific amount of the selected strand using the strand metering mechanism 102, and cutting the selected strand using the cutting mechanism 103. After the selected polymer strand 105 is cut, the strand dispenser 101 may be configured to keep the polymer strand from the first source in the strand dispenser 101 if the next desired fastener is to be cut from the first strand source or to move the polymer strand back out of the strand dispenser 101 and to select a new polymer strand from a second source.

In some embodiments, the device is configured to dispense and cut the predetermined length of polymer strand 105 by manual operation. The strand dispenser 101, strand metering mechanism 102 and cutting mechanism 103 may all function as the result of user action. In other embodiments, the device is configured to dispense and cut the predetermined length of polymer strand 105 by automatic operation. The strand dispenser 101, strand metering mechanism 102 and cutting mechanism 103 may all function automatically with minimal user input. In other embodiments, the device is configured to dispense and cut the predetermined length of polymer strand 105 by a combination of both manual and automatic operations.

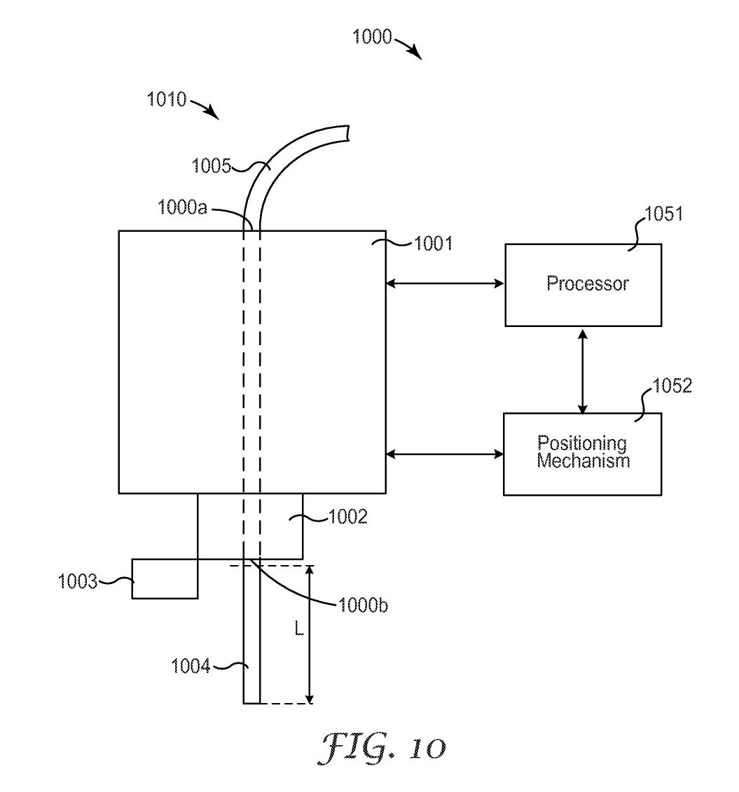

The system 1000 of FIG. 10 contains a device 1010 that may be similar in some respects to the device 100 in FIG. 1. The device 1010 receives one or more polymer strands 1005 from one or more strand sources (not shown in FIG. 10) at the device input 1000a and dispenses the one or more strands at the device output 1000b. In various embodiments, the device 1010 is automated having its operation controlled by a processor 1051 or other circuitry. Optionally, the processor 1051 working in conjunction with a positioning mechanism 1052 may be coupled to control the position of the device 1010. In this configuration, the processor 1051 and positioning mechanism 1052 may operate to move the device 1010 to specified locations on the surface of a workpiece.

The processor 1051 may be programmed to implement software instructions that control the strand dispenser 1001, the metering mechanism 1002, the cutting mechanism 1003, to automatically produce fasteners 1004 having a predetermined length L. For example, the strand dispenser, metering mechanism, and cutting mechanism may include components as previously discussed in connection with FIG. 1, wherein the components are also capable of being controlled by the processor 1051. For example, the system 1000 may be capable of producing fasteners of different lengths, depending on the program instructions. A user may program the different lengths into the system or the processor 1051 may determine the length of the polymer strand based on measured or sensed parameters. One possible parameter could include the depth of the hole where the polymer fastener is to be placed. For example, the processor 1051 may calculate the polymer fastener length based on how much of the polymer fastener should be exposed when dispensed into a cavity.

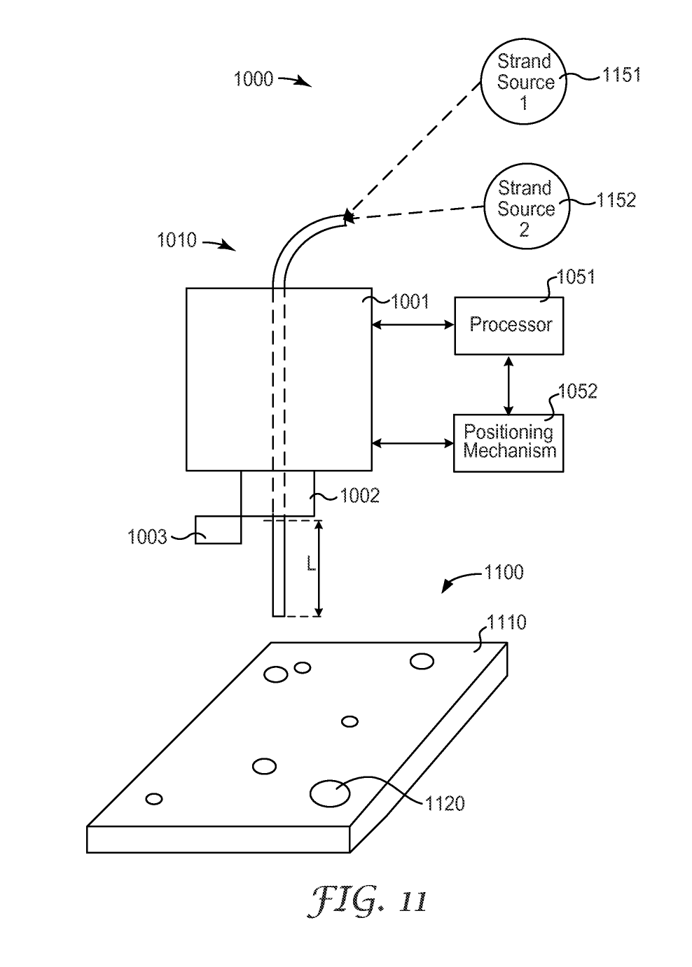

The system 1000 may also contain a positioning mechanism 1052 that moves the strand dispenser and device 1010. The positioning mechanism 1052 may be controllable by the processor 1051. The positioning mechanism 1052 moves the strand dispenser over holes 1120 positioned in a workpiece 1100 as illustrated in FIG. 11. The workpiece 1100 may comprise a planar, two dimensional surface 1110, as illustrated in FIG. 11 or the workpiece may have a more complex shape in three dimensions. The positioning mechanism may be capable of moving in one, two, or three dimensions to position the device 1010 to dispense fasteners. The strand dispenser may be configured to dispense cut polymer strands from multiple sources 1151, 1152 into holes 1120 positioned on the surface 1110 of the workpiece 1100. In some embodiments, the device 1010 is configured to dispense multiple polymer strands having different diameters and/or lengths as previously discussed. The processor 1051 can be configured to control the device 1010 to select the appropriate diameter of the polymer strand dispensed by the device 1010. This action may be based on the diameter of the specific hole 1120 to which the polymer strand is being dispensed.

A user may program the different diameters into the system or the processor 1051 may determine the diameter of the polymer strand based on measured or sensed parameters. One possible parameter could include the diameter of the hole or cavity where the polymer fastener is to be placed. For example, the processor 1051 may calculate the polymer fastener diameter based on the diameter of the cavity. In some embodiments, the processor 1051 may contain a predetermined sequence of various polymer fastener diameters and lengths that are to be dispensed into the holes 1120 of the workpiece 1100.

Particular materials and dimensions thereof recited in the disclosed examples, as well as other conditions and details, should not be construed to unduly limit this disclosure. Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

Various devices and methods are provided.

Embodiment 1 is a device comprising: a strand dispenser configured to dispense a strand of an oriented shape memory polymer configured to expand laterally and contract longitudinally when heated, the strand dispenser including at least two grippers that operate cooperatively to dispense the strand; a strand metering mechanism configured to be operable in conjunction with the strand dispenser to dispense a predetermined length of the strand; and a cutting mechanism configured to cut the strand to form a fastener of the predetermined length.

Embodiment 2 is the device of embodiment 1, wherein the strand dispenser comprises a first structure and a second structure, the first and second structures configured to rotate relative to one another, wherein a first relative movement of the second structure relative to the first structure causes the strand dispenser to dispense the predetermined length and a second relative movement of the second structure relative to the first structure causes the cutting mechanism to cut the strand at the predetermined length.

Embodiment 3 is the device of embodiment 2, wherein the strand metering mechanism includes a stop configured to limit movement of the second structure relative to the first structure during the first relative movement to an amount of relative movement associated with the predetermined length.

Embodiment 4 is the device of embodiment 3, wherein the stop feature is adjustable to adjust the predetermined length.

Embodiment 5 is the device of any of embodiments 2 through 3, wherein the strand dispenser includes first and second grippers; and during the second movement, the second gripper grips the strand; the first gripper allows movement of the strand within the first gripper; and the first and second grippers move apart from one another.

Embodiment 6 is the device of embodiment 5, wherein the strand dispenser is configured so that during the first movement, the first gripper grips the strand; the second gripper allows movement of the strand within the second gripper; and the first and second grippers move toward one another.

Embodiment 7 is the device of any of embodiments 1 through 6, wherein the strand dispenser includes first and second grippers, each gripper configured to grip the strand, and wherein the strand dispenser is configured to move the grippers relative to each other to dispense the predetermined length of the strand.

Embodiment 8 is the device of embodiment 7, wherein the metering mechanism includes a stop configured to limit the relative movement between the first and second grippers.

Embodiment 9 is the device of any of embodiments 7 through 8, wherein the each of the first and second grippers comprises a collet and a sleeve.

Embodiment 10 is the device of embodiment 9, wherein the sleeve is tapered and the collet is split and comprises multiple wedges.

Embodiment 11 is the device of embodiment 10, wherein the collet wedges are serrated and each gripper includes a spring that pushes the collet into the taper of the sleeve.

Embodiment 12 is the device of any of embodiments 10 through 11, wherein each gripper is configured so that when the strand moves in the sleeve in a direction towards a wider portion of the taper, the collet wedges separate allowing the strand to move in the collet.

Embodiment 13 is the device of any of embodiments 1 through 12, wherein the strand dispenser comprises a plate having an aperture and wherein the strand dispenser is configured so that at least the predetermined length of strand extends through the aperture after cooperative operation of the first and second grippers to dispense the strand.

Embodiment 14 is the device of embodiment 13, wherein the strand dispenser is configured so that the second gripper grips the strand while the cutting mechanism cuts the strand at the predetermined length.

Embodiment 15 is the device of any of embodiments 13 through 14, wherein the cutting mechanism comprises a blade that slides over a surface of the plate and across the aperture.

Embodiment 16 is the device of any of embodiments 1 through 15, wherein the strand dispenser comprises a plate having a dispensing surface; and an aperture in the plate; and the cutting mechanism comprises a knife blade disposed proximate to the dispensing surface of the plate, the knife blade including the sharp edge; and a cam follower configured to move the knife blade toward the strand that extends through the aperture.

Embodiment 17 is the device of embodiment 16, wherein the cutting mechanism includes a spring coupled to the knife blade and configured to retract the knife blade away from the aperture.

Embodiment 18 is the device of any of embodiments 1 through 17, wherein the cutting tool is configured to cut the strand with less than 25%, less than 10%, or less than 2% distortion of a cross sectional shape of the strand.

Embodiment 19 is the device of any of embodiments 1 through 18, further comprising: a heater configured to heat the strand after the cutting mechanism cuts the strand at the predetermined length, the heating sufficient to cause the fastener to expand laterally and contract longitudinally at one end of the strand.

Embodiment 20 is a method comprising: operating a strand dispensing device comprising a strand dispenser, a metering mechanism, and a cutting mechanism that are operably connected, the operating comprising: dispensing a strand from the strand dispenser, the strand comprising an oriented shape memory polymer configured to expand laterally and contract longitudinally when heated; metering a predetermined length of the strand during the dispensing; and cutting the strand to form a fastener of the predetermined length.

Embodiment 21 is the method of embodiment 20, wherein dispensing the fastener comprises dispensing a first end of the fastener into an opening in a first workpiece; and after dispensing, metering and cutting; inserting a second end of the fastener into an opening in a second workpiece; and heating the fastener to join the first and second workpieces.

Embodiment 22 is the method of embodiment 21, wherein the opening in at least one of the first and second workpieces is an opening to a blind cavity.

Embodiment 23 is the method of embodiment 21, wherein the opening in at least one of the first and second workpieces is a through hole.

Embodiment 24 is the method of any of embodiments 20 through 23, wherein dispensing the fastener comprises dispensing a first end of the fastener into an opening in a first workpiece; heating the first end of the fastener; and after heating the first end of the fastener, inserting the second end of the fastener into a second workpiece; and heating the second end of the fastener.

Embodiment 25 is the method of any of embodiments 20 through 24, wherein operating the dispensing device comprises manually operating the dispensing device.

Embodiment 26 is the method of any of embodiments 20 through 25, wherein at least one of the dispensing, metering, and cutting is performed by the dispensing device under automatic control.

Embodiment 27 is a device comprising: a strand dispenser configured to dispense a strand; a strand metering mechanism configured to be operable in conjunction with the strand dispenser to dispense a predetermined length of the strand; and a cutting mechanism configured to cut the strand to form fasteners of the predetermined length, wherein the strand comprises an oriented shape memory polymer configured to expand laterally and contract longitudinally when heated.

Embodiment 28 is the device of embodiment 27, wherein the strand dispenser is configured to allow selection of strand diameter.

Embodiment 29 is the device of any of embodiments 27 through 28, wherein the cutting mechanism is configured to cut the strand with less than 25%, less than 10% or less than 2% distortion of a cross sectional shape of the strand.

1. A device, comprising:
a strand dispenser configured to dispense a strand of an oriented shape memory polymer configured to expand laterally and contract longitudinally when heated, the strand dispenser including at least two grippers that operate cooperatively to dispense the strand, wherein the strand dispenser comprises a first structure and a second structure, the first and second structures configured to rotate relative to one another, wherein a first relative movement of the second structure relative to the first structure causes the strand dispenser to dispense the predetermined length and a second relative movement of the second structure relative to the first structure causes the cutting mechanism to cut the strand at the predetermined length; and wherein:
the strand dispenser includes first and second grippers; and during the second movement:
the second gripper grips the strand; the first gripper allows movement of the strand within the first gripper; and the first and second grippers move apart from one another;
a strand metering mechanism configured to be operable in conjunction with the strand dispenser to dispense a predetermined length of the strand; and
a cutting mechanism configured to cut the strand to form a fastener of the predetermined length.

2. (canceled)

3. The device of claim 1, wherein the strand metering mechanism includes a stop configured to limit movement of the second structure relative to the first structure during the first relative movement to an amount of relative movement associated with the predetermined length.

4. (canceled)

5. The device of claim 1, wherein the strand dispenser is configured so that during the first movement:
the first gripper grips the strand;
the second gripper allows movement of the strand within the second gripper; and
the first and second grippers move toward one another.

6. The device of claim 1, wherein:
the strand dispenser includes first and second grippers, each gripper configured to grip the strand, and wherein the strand dispenser is configured to move the grippers relative to each other to dispense the predetermined length of the strand.

7. The device of claim 6, wherein the strand dispenser comprises a plate having an aperture and wherein the strand dispenser is configured so that at least the predetermined length of strand extends through the aperture after cooperative operation of the first and second grippers to dispense the strand.

8. The device of claim 7, wherein the strand dispenser is configured so that the second gripper grips the strand while the cutting mechanism cuts the strand at the predetermined length.

9. The device of claim 1, wherein:
the strand dispenser comprises:
a plate having a dispensing surface; and
an aperture in the plate; and
the cutting mechanism comprises:
a knife blade disposed proximate to the dispensing surface of the plate, the knife blade including a sharp edge; and
a cam follower configured to move the knife blade toward the strand that extends through the aperture.

10. The device of claim 1, wherein the cutting tool is configured to cut the strand with less than 25%, less than 10%, or less than 2% distortion of a cross sectional shape of the strand.

11. The device of claim 1, further comprising a heater configured to heat the strand after the cutting mechanism cuts the strand at the predetermined length, the heating sufficient to cause the fastener to expand laterally and contract longitudinally at one end of the strand.

12. A method, comprising:
operating a strand dispensing device comprising a strand dispenser, a metering mechanism, and a cutting mechanism that are operably connected, the operating comprising:
dispensing a strand from the strand dispenser, the strand comprising an oriented shape memory polymer configured to expand laterally and contract longitudinally when heated;
metering a predetermined length of the strand during the dispensing; and
cutting the strand to form a fastener of the predetermined length.

13. The method of claim 12, wherein:
dispensing the fastener comprises dispensing a first end of the fastener into an opening in a first workpiece; and
after dispensing, metering and cutting;
inserting a second end of the fastener into an opening in a second workpiece; and heating the fastener to join the first and second workpieces.

14. The method of claim 13, wherein the opening in at least one of the first and second workpieces is the opening to a through hole.

15. A device, comprising:
a strand dispenser configured to dispense a strand;
a strand metering mechanism configured to be operable in conjunction with the strand dispenser to dispense a predetermined length of the strand; and
a cutting mechanism configured to cut the strand to form fasteners of the predetermined length, wherein the strand comprises an oriented shape memory polymer configured to expand laterally and contract longitudinally when heated.
